(19) United States
(12) Patent Application Publication
(10) Pub. No.: US 2026/0361007 A1
(43) Pub. Date: Nov. 12, 2026

(54) VEHICLE JUNCTION BOX, MULTI-MATERIAL MULTI-COMPONENT BUSBAR WITH LASER WELDING, AND METHOD

(71) Applicant: Yazaki North America, Inc., Canton, MI (US)

(72) Inventors: Brian Lee Wagner, Ypsilanti, MI (US); Franky Tenka, Canton, MI (US); Akshay Patel, Canton, MI (US); Matthew James Baker, Flatrock, MI (US)

(21) Appl. No.: 19/675,461

(22) Filed: May 12, 2026

Related U.S. Application Data
(60) Provisional application No. 63/804,616, filed on May 12, 2025.

(51) Int. Cl. H01R 4/62; B60R 16/023; H01R 4/02; H01R 25/16; H01R 43/02

(52) U.S. Cl. CPC H01R 4/625; B60R 16/0239; H01R 4/029; H01R 25/161; H01R 43/0221; H01R 2201/26

(57) ABSTRACT

A busbar for use with a vehicle junction box and method for manufacturing the same can include at least one first plate made of Aluminum, at least one second plate made of Copper, and at least one laser weld structure connecting the at least one first plate to the at least one second plate. A high voltage vehicle junction box can include a contactor post that is laser welded to the Aluminum and Copper plates that make up the busbar. The busbar can include a plurality of plates laser welded together, with the plates alternating in material. Further, wires can be laser welded to the busbar, and the busbar can be a simple structure with no threaded screws, posts, or bolts required for connecting electronic components of the vehicle junction box to the busbar.

### CROSS-REFERENCE TO RELATED APPLICATIONS

This application claims priority under 35 U.S.C. §119 to U.S. Provisional Patent Application No. 63/804,616 filed on May 12, 2025, the disclosure of which is hereby incorporated by reference in its entirety.

### BACKGROUND

This disclosure relates to electrical busbars and methods of their construction. In particular, the disclosure relates to a multi material busbar, such as a multilayer busbar, that is constructed by laser welding various materials together and configured for use various applications, including in a high voltage vehicle junction box.

The disclosed subject also relates to improvements in methods for joining circuit components together in a power distribution box. It has been known to use ultrasonic welding of busbar to busbar, or electrical components to busbar, or to each other. Typically, a common material is used between joined busbars and components.

Laser welding electrical components including common or homogenous materials is also conventionally known. However, there is a longfelt need in the vehicle art to use lightweight material that is electrically conductive and that can serve as a busbar to provide voltage pathways between components in a junction box, and in particular a high voltage junction box used in electric motor vehicles. There is a further need to reduce the number of fasteners used in a vehicle junction box in order to lower the weight of the vehicle junction box assembly and to tamper proof certain components of the vehicle junction box that are not appropriate for servicing. A still further need in the art exists to find ways to minimize interface resistance and resultant heat generation in multilayer busbar plates in a vehicle junction box, especially high voltage vehicle junction boxes.

### SUMMARY

Some embodiments are directed to a busbar for use with a vehicle junction box, the busbar including: at least one first plate made of Aluminum; at least one second plate made of Copper; and at least one laser weld connecting the at least one first plate to the at least one second plate.

Some embodiments are directed to a vehicle junction box, including: a housing including a plurality of electronic components located therein; a busbar having at least one first plate made of Aluminum, at least one second plate made of Copper; and at least one of a wire and a terminal post extending from at least one of the plurality of electronic components and connected to the busbar via a laser weld connection structure.

Some embodiments are directed to a method of manufacturing a busbar for connection to a plurality of electronic components of a high voltage vehicle junction box, including: providing at least one first plate made of Aluminum including an aperture therein; providing at least one second plate made of Copper including an aperture therein; providing a high voltage post made of a post material, extending from at least one of the plurality of electronic components; sliding the post into the aperture of the at least one first plate and the aperture of the at least one second plate; and laser welding the post to both the at least one first plate and the at least one second plate such that aluminum and copper of the at least one first plate and the at least one second plate are melted together with the post material.

There is a growing demand for lighter-weight materials with enhanced thermal management which is driven by the demand for higher electrical performance and extended vehicle driving range. While these advanced materials unlock significant benefits, they also introduce new challenges for material suppliers, platers, and interface fastening methods. Specifically, they require solutions that minimize heat generation while enabling faster and more efficient energy transfer. Traditional approaches, such as threaded fasteners, TOX joints, ultrasonic welding, and male/female terminal interfaces, are increasingly constrained by limitations in cost, quality, achievable clamping force, and interface resistance.

### BRIEF DESCRIPTION OF THE DRAWINGS

The disclosed subject matter of the present application will now be described in more detail with reference to exemplary embodiments of the apparatus and method, given by way of example, and with reference to the accompanying drawings, in which:

FIG. 1 is a perspective view of a junction box with busbar made in accordance with principles of the disclosed subject matter.

FIG. 2A is a perspective views of another embodiment of a multilayer busbar connected to electronic components of a vehicle junction box made in accordance with principles of the disclosed subject matter.

FIG. 2B is a perspective view of the multilayer busbar connected to electronic components of a vehicle junction box of FIG. 2A.

FIG. 2C is a top view of the multilayer busbar connected to electronic components of a vehicle junction box of FIG. 2A.

FIG. 2D is a partial cross-section taken along line 2D-2D of FIG. 2A.

FIG. 3 is a magnified view of a portion of FIG. 1.

FIG. 4 is a side partial perspective view of another embodiment of a busbar and vehicle junction box made in accordance with principles of the disclosed subject matter.

FIG. 5 is a perspective view of a copper terminal connected to an aluminum portion of a busbar via laser weld in accordance with principles of the disclosed subject matter.

FIG. 6 is a perspective view of another embodiment of a copper terminal connected to an aluminum portion of a busbar via laser weld in accordance with principles of the disclosed subject matter.

FIG. 7 is a perspective view of a wire melted into connection with an aluminum portion of a busbar via laser weld in accordance with principles of the disclosed subject matter.

FIG. 8 is a perspective view of a copper wire to a copper portion of a busbar via laser weld in accordance with principles of the disclosed subject matter.

### DETAILED DESCRIPTION OF EXEMPLARY EMBODIMENTS

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows.

The disclosed subject matter includes a multi-layer, multi-material busbar that can be formed via laser welding. The laser welding minimizes the interface resistance and heat generation by bonding materials through melting mixing. The laser welding can be used to attach the busbar 20 to various electronic components 56 of the high voltage vehicle junction box 10, such as a high voltage contactor, a pyrofuse, a current sensor, as well as other electronic components. Laser welding can eliminate the need for tin or silver plating at interfaces and can eliminate the need for threaded fastener clamping force between the electronic component(s) and the busbar and between the busbar layers themselves. Use of laser welded connection structures also allows the high voltage junction box to be tamper proof, especially with respect to those components that are not intended to be serviceable.

Typically, a laser weld can be used to secure electrical components to a printed circuit board. For example, a laser weld can be used to melt solder to form electrical connections. In this case, a laser weld is used for only a single layer with common material. No alignment occurs between bonded structures, and solder is used to join structures in this technique.

Laser welding flexible printed circuits to various components can also be accomplished. For example, laser welding a battery cell can be done for cell voltage monitoring. Again, in this case, the laser welds are joining a common material together.

The disclosed subject matter can include a busbar for use in a vehicle junction box. The busbar can include multiple layers with multiple materials used in the layers of the bus bar. Multiple wires can be joined together through ultrasonic welding a nugget at the end of the strands of the wires, and the nugget can be laser welded to the busbar. A high voltage contactor can include a post made of a single material or multiple materials, and can be used to align the busbar and provide material for laser welding the busbar to the contactor pad/post. This type of laser weld connection for the contactor can eliminate or reduce interface resistance and eliminate or reduce the opportunity for fretting corrosion. The disclosed subject matter is applicable for use with a high voltage contactor 44 in a high voltage vehicle junction box 10, and for connection to electronic components 56 such as a pyrofuse, a current sensor, a thermal fuses, a resistor, or other high voltage junction box components.

The disclosed subject matter can also minimize heat generation by reducing or eliminating interface resistance, fretting corrosion, and the need to apply plating to the electronic components and/or busbar layers / plates 26a. Laser welding differing materials such as Aluminum to Copper can eliminate or reduce galvanic corrosion between layered materials. The post that extends from the high voltage contactor 44 (connected or slid into apertures 22 in the busbar plates 26a) can be configured as a double ended stud or a post stud combination made of aluminum or copper. Ultimately, the busbar 20 and contactor 44 can be laser welded together via a contactor pad 46. The laser welding connective structure can be controlled such that a cross-section of the laser weld connection structure is large relative to typical connectors, such that a reduction in interference resistance, and lower heat generation, is achieved as compared to typical connections for the busbar layers / plates 26a and electronic components 56 (typical connections being threaded fasteners, ultrasonic welds between similar materials, etc.) The reduction of busbar cross-section area can also provide increased ability to manage temperature rise in assembly, a reduction of components, reduction of mass / weight for the junction box, and a reduction in assembly cost.

In one embodiment, a single layer busbar 20 and 12mm² wire 52 can be laser welded together with a 2 kW laser system in accordance with principles of the presently disclosed subject matter. The material of the wire 52 can be the same as the busbar 20 or different. For example, the materials can be copper and aluminum. In the case of a multi-layer busbar 20 where certain layer(s) / plates 26a are made from a first material and certain other layer(s) 26b, 26c, etc. are made from a different material, such as copper and aluminum, a 10-12kW laser welding device can be used.

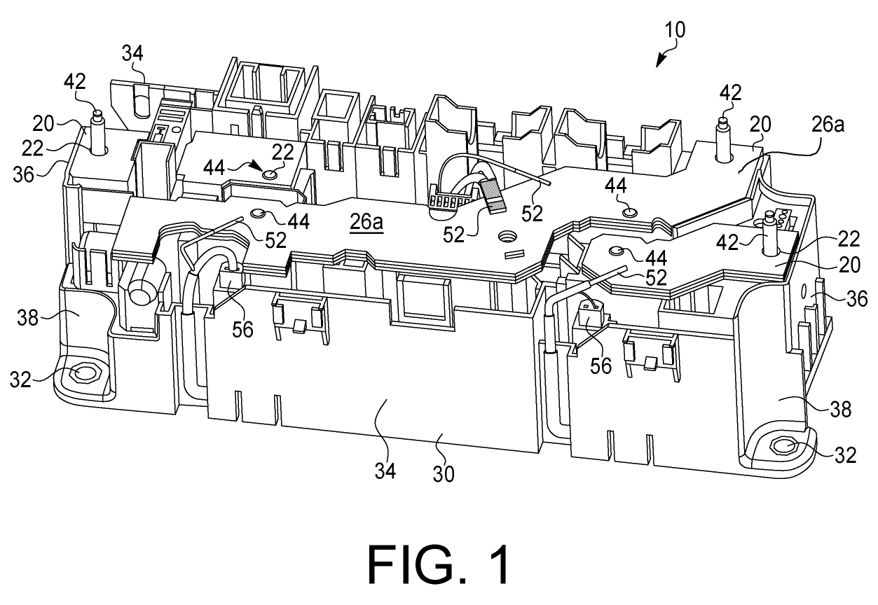

FIG. 1 is a perspective view of a junction box 10 with busbar 20 made in accordance with principles of the disclosed subject matter. In this embodiment, the busbar 20 includes a multilayer busbar that includes apertures 22 for sliding the busbar 20 onto contact connection posts 42 extending from an electronic component(s) 56 within the junction box 10. The multilayer busbar 20 can include a top aluminum plate, bottom aluminum plate, and middle copper plate that are all identical in terms of geometry. The plates could also be arranged differently with an aluminum middle plate and top and bottom copper plates, or any other combination of different material plates. The number of plates 26a can also differ, and can be 2, 4, 5, 6, or more plates. The geometry of the plates can also differ, provided the apertures 22 line up with the connection post(s) 42 and contactor(s) 44 extending from the electronic components 56 when the busbar 20 is attached to the junction box 10.

The plates 26a-c can be laser welded to the contactor(s) 44 after the post(s) 42 is/are slid into the apertures of the plates 26a-c. Alternatively, the plates 26a-c could be laser welded together after being slid onto the contactor(s) 44 by simply welding the post (or the pad) and contactors 44 to the plates 26a-c. In the embodiment shown, the contactor 44 can be made from copper. However, it is conceivable that the contactor 44 be made from aluminum, a combination of aluminum and copper, or other conductive material(s) as well. The laser welding method can also be used to secure a current sensor to the high voltage contactor 44. Other electrical components 56, such as a high voltage contactor, a pyrofuse, a current sensor, as well as other electronic components can be connected to the contactor(s) 44 and/or connection post(s) 42.

The junction box 10 can include a plastic housing 30 that has side walls 34 and end walls 36 that extend from a base on which electronic components 56 are housed. The walls 34, 36 can form a rectangular housing that extend upward from a base to an exposed top area in which the busbars 20 are located. Each busbar 20 can be made from any number of plates 26a stacked on top of each other that can be identical in shape and substantially planar in a plane that extends perpendicular to (or substantially perpendicularly to) the plane containing the majority of the wall 34 surface (or majority of wall 36 surface). Each busbar 20 can also be substantially planar in a plane that extends perpendicular to (or substantially perpendicularly to) the longitudinal axis of each of the contactor 44 and/or connection posts 42. The plates 26a that make up the multilayer busbar 20 can all be aluminum, all copper, alternatively copper and aluminum, or any sequence or combination of aluminum and copper plates 26a. The thickness of the plates 26a can vary or be identical. FIG. 1 shows three different busbars 20 located in the exposed top area of the housing 30. Each busbar 20 includes a high voltage connection post 42 and a high voltage contactor 44. Apertures 32 can be provided in concave cut outs 38 in the housing 30 for connection to a vehicle via bolts inserted through the apertures 32. Of course, other connection structures can be used to connect the junction box 10 within a vehicle, such as welds, clamps, clips or other known mechanical or chemical fasteners.

Various electrical components 56 within the junction box 10 can be connected to the busbar 20 via any or all of the contactor(s) 44, connection post(s) 42 or wire connector(s) 52. Wiring harness(es) (not shown) that extend away from the junction box 10 can be connected via the connection post(s) 42 to the junction box 10. The contactors 44 and connection posts 42 can have longitudinal axes that are perpendicular to (or substantially perpendicular to) the top surface of the plates 26a. Each of the plates 26 can include apertures 22 that have a central axis that coincides with a respective longitudinal axis of one of the posts 42 and/or contactors 44 located within a respective aperture 22. By contrast, the wire connector(s) 52 can be laser welded to a top surface of the uppermost plate 26a.

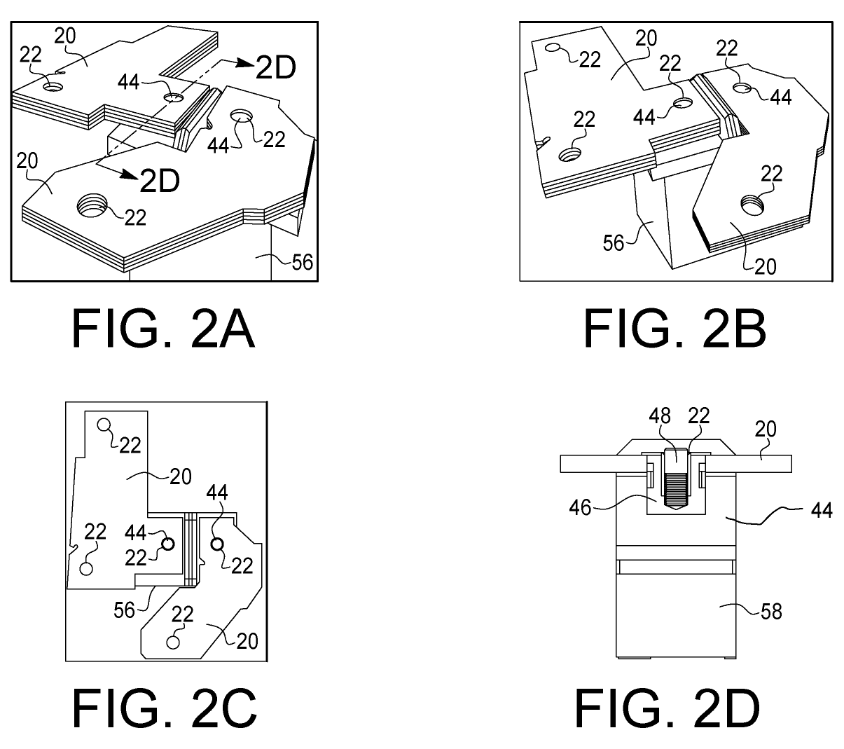

FIG. 2A is a perspective view of another embodiment of a multilayer busbar 20 connected to electronic components 56 of a vehicle junction box 10 made in accordance with principles of the disclosed subject matter. The multilayer busbar 20 can include all aluminum plates 26a-c. However, it is possible that the busbar 20 include a top aluminum plate 26a, bottom aluminum plate 26c, and middle copper plate 26b that are all identical in terms of geometry. The busbar 20 can also include additional plates and the material of each plate can alternate, or a plurality of a same material plates can be stacked together adjacent a different material plate(s). The plates 26a-c can be slid onto terminal connection posts 42 and/or contactors 44 extending from electronic components that are to be located within the junction box 10 either before or after assembly and connection of the busbar 20 to the electronic component(s) 56. The post(s) 42, and contactor(s) 44 can be the same or different material as compared to the plates 26a-c and, for example, can be copper post(s) 42, contactor(s) 44, or aluminum post(s) 42, contactor(s) 44 or different material post(s) 42, contactor(s) 44 that are laser welded to the plates 26a-c.

FIG. 2D is a cross-section taken along line 2D-2D of FIG. 2A and shows a laser welded connection structure between the busbar 20 and a high voltage connection contactor 44. The contactor 44 can include a weld element 48 that is made of aluminum or copper and is located in aperture 22 of the busbar 20. A copper contact pad 46 can be provided for facilitating connection between the contactor 44 and busbar 20. The busbar 20 can be aluminum in this embodiment, or can be a combination of aluminum and copper plates 26a-c, or solely copper plates. High voltage contactor 58 can be connected to electronic components 56 within the junction box 10.

FIG. 2B is another perspective view of the multilayer busbar 20 connected to electronic components 56 of a vehicle junction box 10. The busbar plates 26a-d can be all aluminum plates, or can alternate aluminum and copper plates. The high voltage contactor 44 can include a copper post that is laser welded to the plates 26a-d. Alternatively, the high voltage contactor 44 can include an aluminum post that is laser welded to the plates 26a-d.

FIG. 2C is a view of the multilayer busbar connected to electronic components of a vehicle junction box 10. In this embodiment, the laser weld can form an aluminum / copper weld element (laser weld connection structure) that secures both the plates to the high voltage contactor 44 and the plates 26a-d to themselves. A copper contact pad 46 is provided in this embodiment and the busbar 20 is made from aluminum plates 26a-d. Thus, the laser weld connection structure will be a mix of copper and aluminum that secures the contactor 44 to the busbar 20 as well as secures the busbar plates 26a-d together.

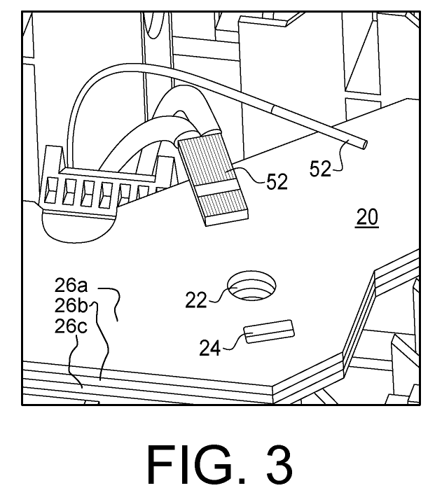

FIG. 3 is a magnified annotated view of a portion of FIG. 1 in which the busbar 20 is formed by a combination of aluminum and copper plates 26a-c, and a copper wire 52 is shown connected to a top planar surface of the busbar 20 via a laser weld connection structure. Aperture 22 can accommodate a contactor 44 for connection to the busbar 20 if desired. Another aperture 24 can be provided in the busbar 20 that provides a location for an anchor structure associated with a wire 52 to be inserted, such that a wire 52 can be held in place and easily welded to the top surface of the busbar 20.

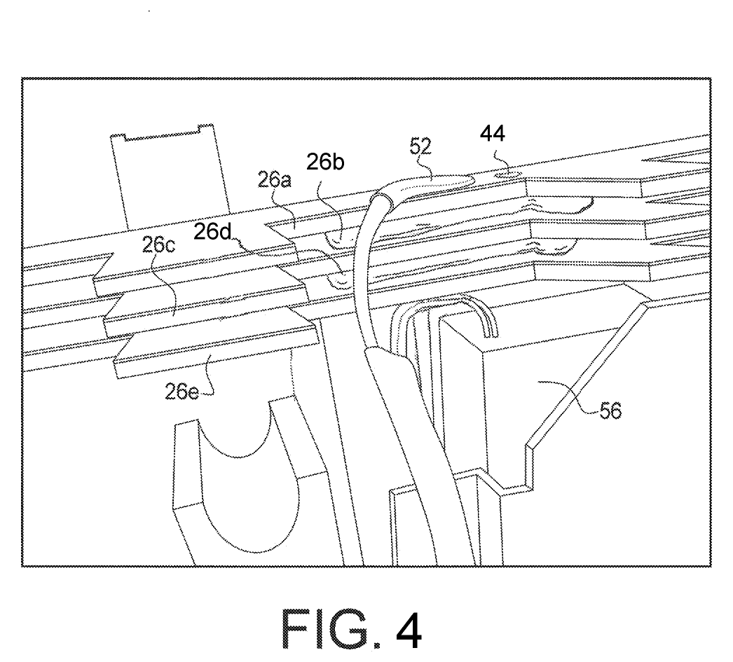

FIG. 4 is a side partial perspective view of another embodiment of a busbar 20 and vehicle junction box 10 made in accordance with principles of the disclosed subject matter. In this embodiment, the busbar 20 includes a copper top layer 26a, a copper bottom layer 26e, and three middle layers 26b-d made from aluminum. However, other combinations of materials and layering sequences are contemplated and fall within the scope of the presently disclosed subject matter. Wire 52 can be laser welded to a top surface of the top layer / plate 26a. An electronic component 56 can be connected to the busbar 20 by the wire 52.

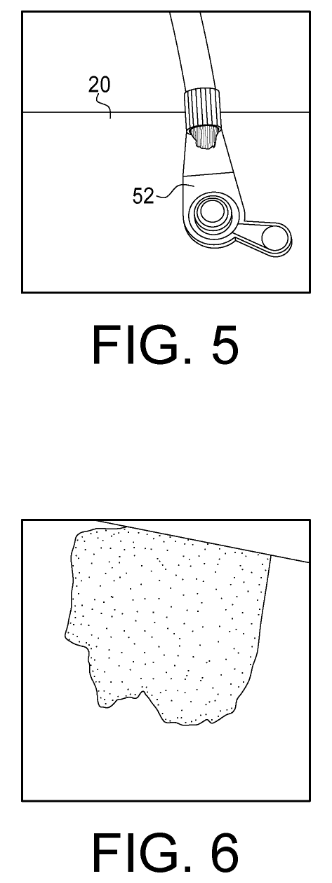

FIG. 5 is a perspective view of a copper terminal of a wire connector 52 connected to an aluminum portion of a busbar 20 via laser weld in accordance with principles of the disclosed subject matter. As can be seen, the connection structure resulting from the laser welding provides a large cross sectional area in which electricity can flow, reducing heat generation. The lack of threaded connectors allows the connection to be stress free in order to provide the many associated advantages noted above with such a connection (e.g., minimizing heat generation by reducing or eliminating interface resistance, eliminating or reducing galvanic corrosion, fretting corrosion, and/or the need to apply plating to the electronic components and/or busbar layers as well as making the device tamper proof).

FIG. 6 is a perspective view of another embodiment of a copper terminal 52 connected to an aluminum portion of a busbar 20 via laser weld in accordance with principles of the disclosed subject matter. This view shows the extent to which the laser welding process allows the copper and aluminum to mix to form a strong, conductive, and stress free connection between a wire 52 / electronic component and the busbar 20 to achieve the many benefits and advantages associated with such a connective structure, as noted above.

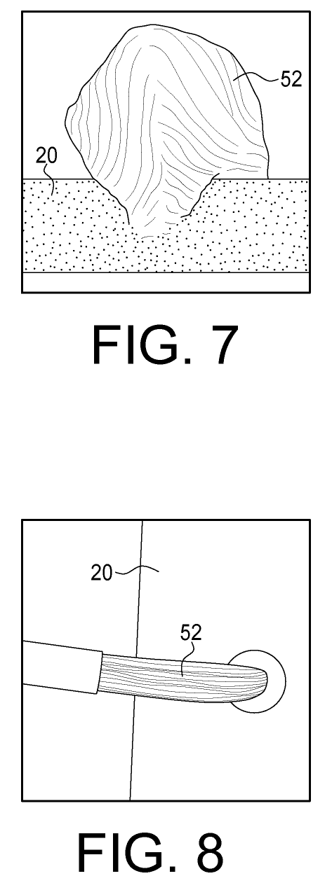

FIG. 7 is a perspective view of a wire 52 melted into connection with an aluminum portion of a busbar 20 via laser weld in accordance with principles of the disclosed subject matter. The high level of mixing forms a strong, conductive, and stress free connection which reduces or eliminates interface resistance as well as providing the other benefits and advantages associated with this laser weld connection structure as noted above.

FIG. 8 is a perspective view of a copper wire 52 to a copper portion of a busbar 20 via laser weld in accordance with principles of the disclosed subject matter.

The presently disclosed subject matter introduces a scalable, stackable aluminum busbar 20 solution that integrates advanced laser welding (LW) technology to reliably create aluminum-to-copper interfaces. The disclosed subject matter is directed to dissimilar‑material laser welding which can enable significant reductions in assembly mass and heat generation, improve heat dissipation within compact packaging, support modular architectures across varying power levels, and enhance manufacturing automation efficiency.

Efficient, optimized electrical interfaces can provide effective thermal management in hybrid and battery electric vehicle designs. As battery packs continue to increase in energy density and power transfer rates, particularly during DC fast charging and high‑performance driving, heat generation at electrical interfaces has become a thermal challenge. Traditional fastening methods are no longer sufficient to adequately minimize interface resistance under these demanding conditions.

To address this need, one aspect of the disclosed subject adopts the more advanced electrical connection technologies described above to, in certain circumstance, enable improved performance, enhanced reliability, and superior thermal management. Moreover, traditional connection such as threaded fasteners and eyelets introduce levels of contact resistance that are no longer acceptable for high‑current and high‑power electrical systems. The disclosed subject matter can reduce the level of contact resistance while streamlining the manufacturing process and reducing vehicle weight and manufacturing cost and time.

Copper has a relatively lower coefficient of thermal expansion and higher stiffness compared to aluminum.

Aluminum has a higher coefficient of thermal expansion, lower modulus of elasticity, and is more susceptible to creep and stress relaxation under sustained load, particularly at elevated temperatures. These characteristics can lead to a loss of clamping force over time if not properly managed.

The disclosed subject matter of laser welding dissimilar materials (as well as similar materials) can provide improved thermal performance by removing the air gap present in bolted interfaces and replacing it with a continuous solid-state metallic bond formed during the liquid phase of welding.

Using laser (and other) welding techniques to connect various electric vehicle components can result certain challenges. Successful implementation can include careful selection of base materials, precise control of process parameters, optimized weld depth, focal spot size, and the appropriate laser welding system architecture. Heat input can be tightly controlled, particularly when joining conductive components to composite electronic assemblies, to prevent functional degradation during processing.

Aluminum-to-copper laser welded interfaces demonstrated lower interface resistance and improved thermal performance compared to copper-to-copper joints. This outcome is likely attributed to the effective disruption of oxide layers and the formation of a fully enclosed, environmentally protected metallic interface. Final interface resistance values can be measured in certain instances at less than one-third of those associated with threaded fastener joints.

Additional system-level advantages were observed due to aluminum’s lower density, resulting in greater mass reduction compared to copper-only designs. Furthermore, aluminum’s higher heat capacity contributed to lower operating temperatures in assembled systems. As with copper-to-copper laser welding, the elimination of air gaps and the formation of a mixed-metallic bond during the liquid phase created a significantly enhanced thermal conduction path.

While we have described apparatus and methods for busbar and high voltage vehicle junction box construction, the disclosed subject matter can be applied to other applications, such as junction boxes for utilities at buildings and home structures, or even for low voltage junction boxes within a vehicle or other device. The components of each of the disclosed embodiments noted above can be interchanged with components of other embodiments to form part of the present disclosure. For example, a threaded connection structure can be used to connect a portion of the busbar to an electronic component, while a laser weld is used to connect a different portion of the busbar to another electronic component within the junction box.

Although laser welding is described above for connecting the busbar 20 to wires 52, contactors 44, and connection posts 42, it is contemplate that other forms or welding could be used, including resistance welding, diffusion welding, TIG/MIG welding (and other material melting joining methods). Both seam / butt laser welding and overlap laser welding are also contemplated for use with the presently disclosed subject matter. The apertures 22 can be the same size in each busbar 20 and plates 26a, but can also vary between plates (for example, can taper along the longitudinal axis of the contactor 44 or connection post 42 which can be similarly tapers for press or close fit). Also, the contactor(s) 44 can connect to a dimple or a flat surface in the busbar 20 (the busbar 20 need not include an aperture 22 for connection to the contactor(s) 44). Although, apertures 22 allow for easy alignment of the busbar 20 with the contactor(s) especially if no connection post 42 is present on a particular busbar 20.

The disclosed junction box 10 is intended for use in a high voltage electric vehicle environment. The junction box 10 can also be configured for use in high current or high power applications.

The busbar 20 can be plated with tin, nickel or silver or other known plating material in order to prevent galvanic corrosion between plates and between different materials of the contactor(s) 44, wires 52 or connection posts 42.

Optimization of laser power, travel speed, and weld path geometry has enabled the disclosed subject matter to be successfully applied within sensitive assemblies such as Battery Disconnect Units (BDUs), without inducing functional degradation.

Use of dedicated fixturing can maintain precise part alignment during laser welding and can also absorb or shield UV and radiant energy from the laser welding process, preventing unintended exposure of surrounding components. This protective approach can maintain long‑term component reliability, electrical performance, and assembly appearance.

Both copper and aluminum naturally form stable oxide layers that provide inherent protection against environmental exposure. These oxide layers serve as effective barriers to corrosion and reduce the need for additional surface treatments, such as tin or nickel plating, at laser‑welded interfaces.

The presently disclosed subject matter can be used in various vehicle applications, such as in a junction box 10, but also in an electric vehicle battery disconnect units, service disconnects and plugs (SDs/SPs), busbar modules and cell connection systems (BBMs/CCSs), battery packs, and busbars as well as other vehicle and non-vehicle applications.

While the subject matter has been described in detail with reference to exemplary embodiments thereof, it will be apparent to one skilled in the art that various changes can be made, and equivalents employed, without departing from the scope of the invention.

What is claimed is:

1. A busbar for use with a vehicle junction box, comprising:
at least one first plate made of Aluminum;
at least one second plate made of Copper; and
at least one laser weld connecting the at least one first plate to the at least one second plate.

2. The busbar of claim 1, wherein the at least one first plate has at least one aperture for receiving a terminal post, and the at least one second plate has at least one aperture that is aligned with the at least one aperture in the at least one first plate for receiving the terminal post.

3. The busbar of claim 2, wherein the busbar consists of the at least one first plate, the at least one second plate, and the at least one laser weld.

4. The busbar of claim 2, wherein the busbar consists of a plurality of first plates, a plurality of second plates, and the at least one laser weld.

5. The busbar of claim 4, wherein the busbar is configured to be connected to components of the vehicle junction box without the use of a threaded fastener.

6. The busbar of claim 1, further comprising:
a laser weld connection structure configured to connect the busbar to a post of a high voltage contactor.

7. The busbar of claim 1, further comprising:
a laser weld connection structure configured to connect the busbar to a high voltage electronic component selected from the group consisting of: a high voltage contactor, a pyrofuse, a current sensor, and a wire post of a high voltage contactor.

8. A junction box, comprising:
a housing including a plurality of electronic components located therein;
a busbar having
at least one first plate made of Aluminum,
at least one second plate made of Copper; and
at least one of a wire and a terminal post extending from at least one of the plurality of electronic components and connected to the busbar via a laser weld connection structure.

9. The junction box of claim 8, wherein the at least one first plate has at least one aperture for receiving the terminal post, and the at least one second plate has at least one aperture that is aligned with the at least one aperture in the at least one first plate for receiving the terminal post.

10. The junction box of claim 8, wherein the busbar consists of a plurality of first plates, and a plurality of second plates.

11. The junction box of claim 8, wherein the junction box is a high voltage junction box configured for use with an electric motor vehicle.

12. The junction box of claim 8, wherein the junction box is a high voltage junction box and the at least one first plate and the at least one second plate are connected to each other by the laser weld connection structure, and the laser weld connection structure is a plate laser weld connection structure.

13. The junction box of claim 8, wherein the busbar is a multilayer busbar having at least four layers alternating between the at least one first plate and the at least one second plate such that the layers alternate between an Aluminum plate and a Copper plate, and each of the at least one first plate and the at least one second plate is plated with a nickel, tin or silver material.

14. The junction box of claim 8, wherein the electronic components include at least one of a high voltage contactor, a pyrofuse, and a current sensor.

15. A method of manufacturing a busbar for connection to a plurality of electronic components of a high voltage junction box, comprising:
providing at least one first plate made of Aluminum including an aperture therein;
providing at least one second plate made of Copper including an aperture therein;
providing a high voltage post made of a post material, extending from at least one of the plurality of electronic components;
sliding the post into the aperture of the at least one first plate and the aperture of the at least one second plate; and
laser welding the post to both the at least one first plate and the at least one second plate such that aluminum and copper of the at least one first plate and the at least one second plate are melted together with the post material.

16. The method of manufacturing a busbar of claim 15, wherein the post is made from copper.

17. The method of manufacturing a busbar of claim 15, wherein
providing at least one first plate made of Aluminum including an aperture therein includes providing a plurality of first plates made of Aluminum including an aperture therein; and
providing at least one second plate made of Copper including an aperture therein includes providing a plurality of second plates made of Copper including an aperture therein.

18. The method of manufacturing a busbar of claim 15, further comprising:
laser welding the at least one second plate made of Copper with the at least one first plate made of Aluminum prior to the step of sliding.

19. The method of manufacturing a busbar of claim 15, further comprising:
providing a wire terminal adjacent a planar surface of at least one of the first plate made of Aluminum and second plate made of Copper; and
laser welding the wire terminal to the planar surface.

20. The method of manufacturing a busbar of claim 15, wherein the electronic components include at least one of a high voltage contactor, a pyrofuse, a current sensor; and the method further includes,
laser welding the busbar to a post of the high voltage contactor, forming a laser weld connection structure between the busbar and the post such that the weld extends into the post of the high voltage contactor.
